(19) United States
(12) Patent Application Publication
(10) Pub. No.: US 2023/0024478 A1
(43) Pub. Date: Jan. 26, 2023

(54) Wind Energy Apparatus

(71) Applicant: Thusitha Kumarasena, Wellesley Hills, MA (US)

(72) Inventor: Thusitha Kumarasena, Wellesley Hills, MA (US)

(21) Appl. No.: 17/873,987

(22) Filed: Jul. 26, 2022

Related U.S. Application Data
(60) Provisional application No. 63/225,693, filed on Jul. 26, 2021.

(51) Int. Cl. F03D 9/34; F03D 1/06

(52) U.S. Cl. CPC F03D 9/34; F03D 1/0675

(57) ABSTRACT

Apparatus is provided for wind-energy electrical generation. The apparatus presented comprises a shell enclosing a turbine with a vertical axis, the shell having a wind intake and wind egress, and may comprise blades or vanes to direct wind flow inside the shell to push the turbine. The turbine comprises an electrical generator. The turbine axis may be able to tilt. The apparatus may be used for wind-energy electrical generation in sites that are not conducive to convention wind-energy electrical generation. The present disclosure solves problems with the currently available apparatuses for wind-energy electrical generation using a building or other obstacle to its advantage. It also provides a means of combining solar and wind renewal energy harvesting into a single device.

### FIELD OF THE INVENTION

The presently disclosed subject matter relates to providing apparatus for electrical power generation from wind, and more particularly, to apparatus for low profile vertical-axis or off-vertical-axis turbines for electrical power generation using the wind flow over a building roof or other obstacle to its advantage.

### BACKGROUND OF THE INVENTION

Utilization of wind energy is a key aspect of renewable energy generation. The current wind turbines used in wind energy harvesting (the use of wind energy for generation of electrical power) typically consist of turbines mounted on tall masts, paired with an electrical power generator. The atmospheric natural wind flow drives the turbines. These turbines are large and are generally suitable for open terrain applications, where they become very noticeable features of the landscape. The electrical power generated by wind must be then transmitted to the end user through some type of electrical grid. There are other smaller turbines available for home-owner use, but these are basically smaller versions of the same application where a wind turbine is mounted on a mast so they can be placed at a sufficient elevation above the ground, with the goal that wind flow is not interrupted by features such as buildings and trees.

There is increasing need to make tall buildings and other facilities be less reliant on non-renewable power sources and be more reliant on renewable energy, so that any such facilities come closer to the ideal of a net-zero emissions target. As a result, many building owners are using roof mounted solar panels to generate some part of the energy needed for the operation of the building, or other facility. However, tall buildings and other structures could increase their generation of renewable energy, and increase the proportion of the energy they use that is renewable energy, through harvesting of wind energy. At present, the use of conventional stand-alone wind turbines in urban areas is generally difficult due to presence of buildings and other space requirements, due to siting requirements, the need for space to the sides, and for the height of the masts and turbines required. The mounting of large conventional mast-mounted wind turbines on top of buildings is not desirable or possible due to several different factors. The small-scale, conventional wind-turbines that one sees on top of building on rare occasions are not of a scale sufficient for making a significant reduction in the facility energy requirements.

Conventional land-based wind turbines are in locations far from the cities where electricity is often most needed (see Advances & Challenges of Wind Energy; U.S. Department of Energy, Wind Energy Technologies). The main types of wind turbines in use today are variations of the typical Horizontal Axis Wind turbine (HAWT) that are mounted on towers (see “The Main Types of Wind Turbines Being Used Today”, Arcadia Blog, Jul. 15, 2017). Another type of wind-energy electrical generation apparatus in use is the Diffuser-Augmented Wind Turbine, in which a smaller scale conventional land-based wind turbine is mounted within a shroud. Another type of wind-energy electrical generation apparatus, known as a Savonius Turbine, comprises a small-scale S-shaped wind turbine with a tall vertical axis. Examples of the Savonius Turbine can be mounted on roof tops, but these are capable of only limited energy production, and would produce significant visual distractions if they were put into wide-spread applications, which limits their usefulness and acceptance.

Accordingly, a need exists for wind-energy electrical generation apparatus that can be used on existing structures, such as buildings, towers, and bridges, without the siting requirements of conventional wind-energy electrical generation apparatus, and which may be accepted and widely used.

### SUMMARY OF THE INVENTION

The present disclosure meets all these needs, by disclosing apparatus for wind-energy electrical generation that may be compact or large, that do not require a tall vertical mast or relatively large amounts of open space around them, or height above their surroundings to reach a region of relatively unobstructed wind flow.

The present disclosure introduces a product that allows installation and use of wind-energy electrical generation apparatus without requiring a tall mast to be significantly above the surroundings. The shallow vertical profile of the apparatus of the present disclosure make it well suited for use and installation on, for instance, the roof-top of a tall building. The shallow profile of the present disclosure makes it ideal for such applications, and the enclosures described can be designed to blend in with the architectural design of the building or other facility.

Further, the present disclosure addresses the problems of the prior art, which do not present apparatus for wind-energy electrical generation that may be used in relatively small spaces, and in urban or dense areas without being rejected as unsightly or unacceptable.

The apparatus of the present disclosure offers multiple advantages over the prior art. The apparatus of the present disclosure can be mounted on tall buildings, both new construction and retrofitted to existing construction, and does not require separate mast and foundation structures, and therefore provides a cost advantage. The apparatus is ideal for use in dense urban areas where free-standing wind turbines are not practical or not preferred due to their visual impact and requirements for space. The apparatus can be used to create urban wind farms by mounting multiple of them on densely located buildings typical of an urban landscape. Power generated using the apparatus is local to the end user, which is similar to roof-mounted solar photovoltaic cells. The apparatus may also include solar cells, increasing the amount of renewable energy generated.

The apparatus of the present disclosure offers advantages over the prior art because they are easier to maintain, inspect, and repair, as the turbine and the power generation systems are located at the building roof where access is readily available. The apparatus may be preferred by building owners and builders due to ease of installation and use, and to increase the use of renewable energy, and qualify buildings for renewable-energy and/or energy-efficiency certifications. The assembly and construction of the apparatus of the present disclosure can be relatively flexible and can be customized to be compatible with the general building architecture, offering further advantages over the prior art. The apparatus may be used on any structures, such as elevated water tanks, and where there are energy demands, the energy generated can be used in operations (e.g., a pump on a water tower) or other use around the facility. The apparatus can be used in remote areas, for direct power or for charging batteries or other energy-storage apparatuses. The apparatuses can be applied unobtrusively in natural landscapes, such as near ocean cliffs and mountain ranges where favorable wind conditions exist. The apparatus offers advantages over the prior art in reducing harm to wildlife, such as birds, from impacts with the blades of conventional open air wind turbines. The openings in the apparatus can be obstructed with a suitable screen to further keep wildlife safe.

In one aspect, the present disclosure comprises an apparatus for wind-energy electrical generation.

These aspects of the present disclosure, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present disclosure are described with reference to the following drawings, in which:

FIG. 1 shows a side elevation view of an aspect of the apparatus of the present disclosure.

FIG. 2 shows a front elevation view of an aspect of the apparatus of the present disclosure.

FIG. 3 shows a top plan view with partial cut-away of an aspect of the apparatus of the present disclosure.

FIG. 4 shows a back elevation view of an aspect of the apparatus of the present disclosure.

FIG. 5 shows an isometric front elevation view of an aspect of the apparatus of the present disclosure.

FIG. 6 shows an isometric back elevation view of an aspect of the apparatus of the present disclosure.

FIG. 7 shows an exploded side elevation view of an aspect of the apparatus of the present disclosure.

FIG. 8 shows a top plan view with partial cut-away of an aspect of the apparatus of the present disclosure.

### DETAILED DESCRIPTION OF THE DRAWINGS

The presently disclosed invention is described with specificity to meet statutory requirements. But, the description itself is not intended to limit the scope of this patent. Rather, the claimed disclosure might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described. The word “approximately” as used herein means within 5% of a stated value, and for ranges as given, applies to both the start and end of the range of values given.

In the following description, numerous specific details are set forth to provide a thorough understanding of the disclosure. But, the present disclosure may be practiced without these specific details. Structures and techniques that would be known to one of ordinary skill in the art have not been shown in detail, in order not to obscure the disclosure. Referring to the figures, it is possible to see the various major elements constituting the apparatus and methods of use the present disclosure.

The present disclosure comprises an apparatus 100 for wind-energy electrical generation.

At the top elevation of a building of sufficient height, the wind speed is naturally higher due to the elevation above ground. In addition, the wind flow is further accelerated in the vicinity of the building roof due to the obstruction of the wind flow due to the presence of the building. The apparatus 100 described herein uses the altered or augmented characteristics of wind flow due to the presence of an obstacle as favorable factors and to its advantage.

Further outer surfaces of the apparatus allow deployment of photovoltaic panels combining two of the more prominent renewable energy sources, namely wind energy and solar energy for electrical power generation.

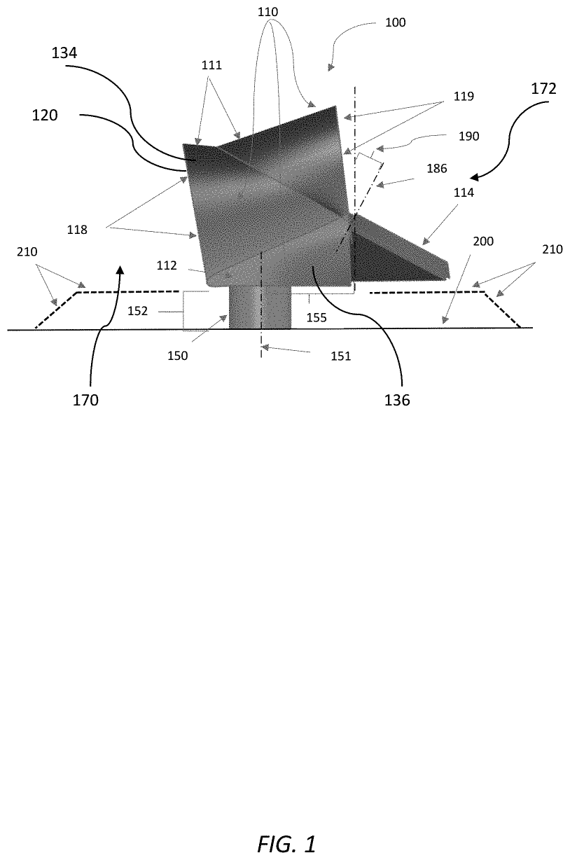

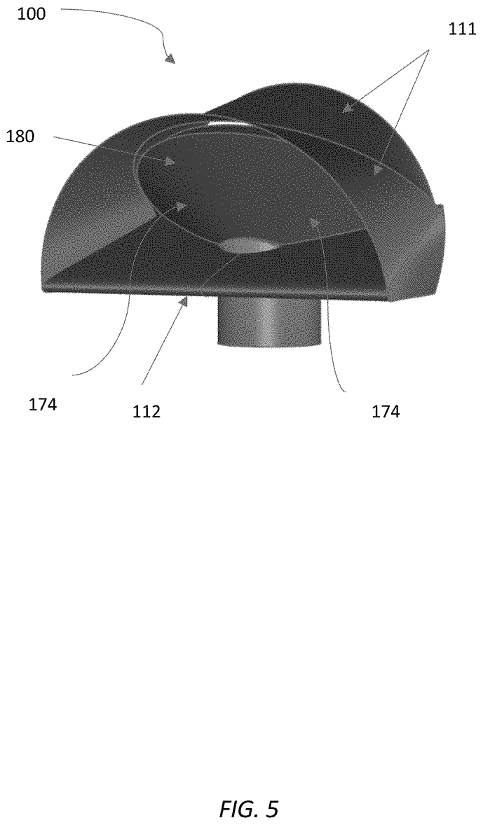

With reference to FIGS. 1, 2, 3, 4, 5, 6, 7, and 8, the apparatus 100 for wind-energy electrical generation of the present disclosure comprises a shell structure 110 mounted on a central columnar support mount 150, which may comprise an axis 151 about which the apparatus 100 is pivoted and is able to rotate, and wherein the axis 151 may be vertical or approximately vertical. In some aspects of the present invention, the axis 151 may be inclined relative to a vertical reference in a manner similar to the inclination of a turbine axis 186, as described further herein. The shell structure 110 comprises an upper shell 111 and a lower nosing shell 112 and a bypass prevention shell 114 wherein the upper shell 111, lower nosing shell 112 and the bypass prevention shell 114 may be securely affixed to each other to comprise at least a part of the shell structure 110. The shell structure 110 may further comprise a plurality of directional vanes 116, and/or a plurality of wind intake zones 118, and/or a plurality of wind egress zones 119. The plurality of wind intake zones 118 and the plurality of wind egress zones 119 may also be provided with wind-porous screens 120 to prevent birds, wildlife, and airborne debris entering into the apparatus 100.

The shell structure 110 is mounted on the central columnar support mount 150 so that the shell structure 110 may be pivoted on the axis 151 of the central columnar support mount 150 using a shell structure articulation base 156. The shell structure articulation base 156 may be pivoted with a setback 155 from the axis 151. Alternatively, the shell structure and the articulation base may also be pivoted with a set forward or a neutral positioning with respect to the axis 151. In the absence of a setback 155, and with a set forward or neutral mounting, the shell structure 110 may, in some aspects, comprise the plurality of directional vanes 116 and/or other electro-mechanical or mechanical articulation control apparatus to keep the plurality of wind intake zones 118 and the plurality of wind egress zones 119 oriented with the varying wind directions, as the prevailing wind direction changes. Accordingly, in all of the pivoting and mounting configurations, whether setback, set-forward or neutral, the apparatus 100 is able to rotate about the axis 151, whether the axis 151 is vertical or approximately vertical, or inclined relative to a vertical reference, such that the apparatus 100 can align with a prevailing wind direction. The plurality of directional vanes 116 assists the apparatus 100 to align with the prevailing wind direction.

The central columnar support mount 150 may, advantageously, be attached or mounted to an existing structure 200, which existing structure 200 may be a building, a bridge, a tower, a water tower or water tank, or other type of object or facility. The existing structure 200 may, alternatively, be any natural landscape feature, such as oceanside hills and cliffs, and mountain ranges, where wind conditions driven by topographical features generate conditions suitable for the use of the apparatus 100. In such uses, the apparatus 100 offers advantages over the tall conventional turbines due to the less obtrusive profile of the apparatus 100, allowing the apparatus 100 to be blended with the terrain.

A height 152 of the central columnar support mount 150 allows the apparatus 100 to be mounted above the interfering features in the vicinity, including but not limited to the equipment on a building rooftop. The height 152 may also be selected to maximize the airflow through the apparatus 100 depending on the specifics of the existing structure 200. The existing structure 200 may also be provided with suitable shielding, covers or additional cladding 210 to improve airflow as well as to meet specific architectural and maintenance requirements of the existing structure 200.

When the apparatus 100 is mounted on, or otherwise attached to, an existing structure 200, the shell structure 110 and the existing structure 200 generate a region of relatively increased air velocity and/or air pressure 170 on a windward side (the side facing the wind flow) of the shell structure 110 and a region of relatively reduced air velocity and/or air pressure 170 on a leeward side (the side facing away from the wind flow) of the shell structure 110, such that there is a difference in air pressure and air velocity. This combined with the deviation of the wind flow over the upper shell 111 generates a region of varying air velocity and air pressure 172 between the plurality of wind intake zones 118 and the plurality of wind egress zones 119 of the shell structure 110. This difference in air pressure and air velocity drives a wind flow 174 through the shell structure 110 and through a shallow-profile wind turbine 180 mounted internally within the shell structure 110.

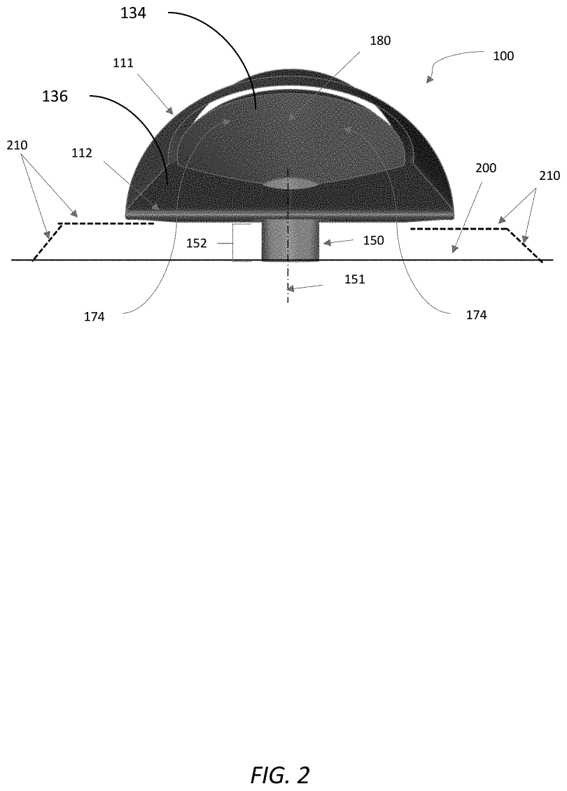

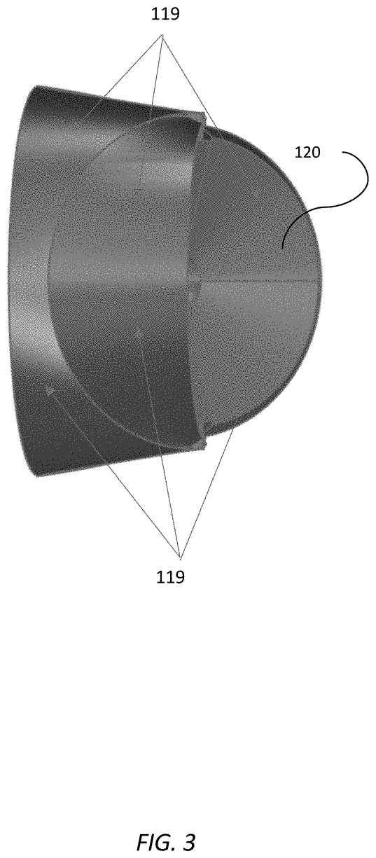

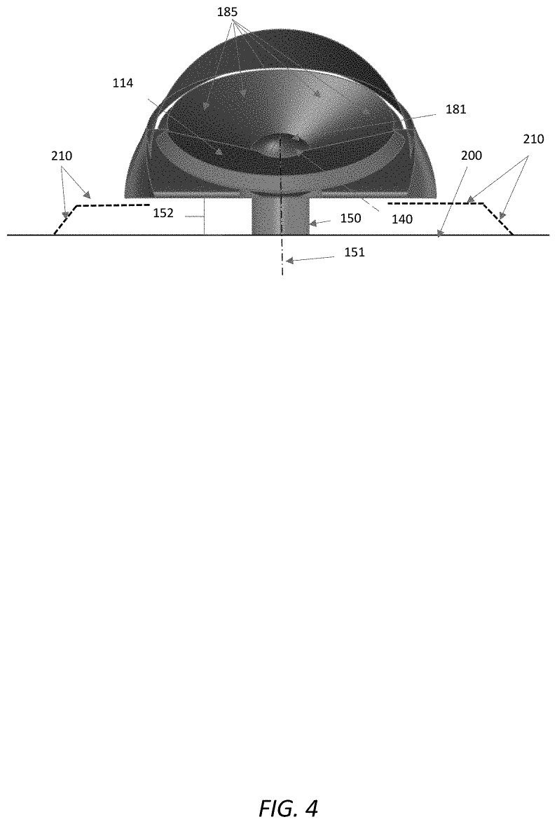

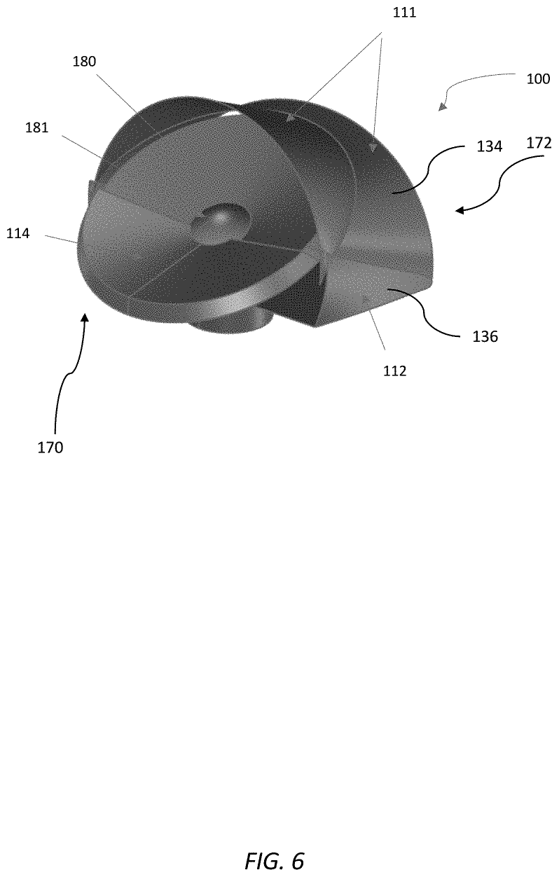

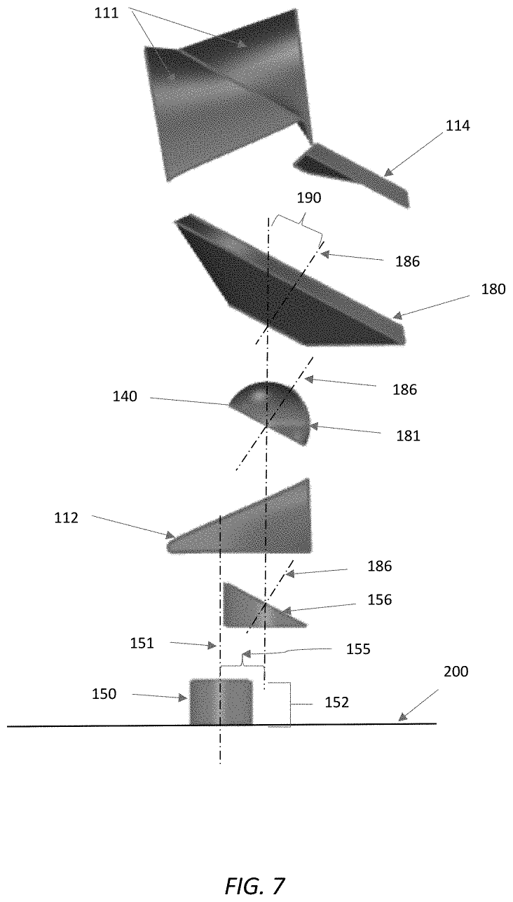

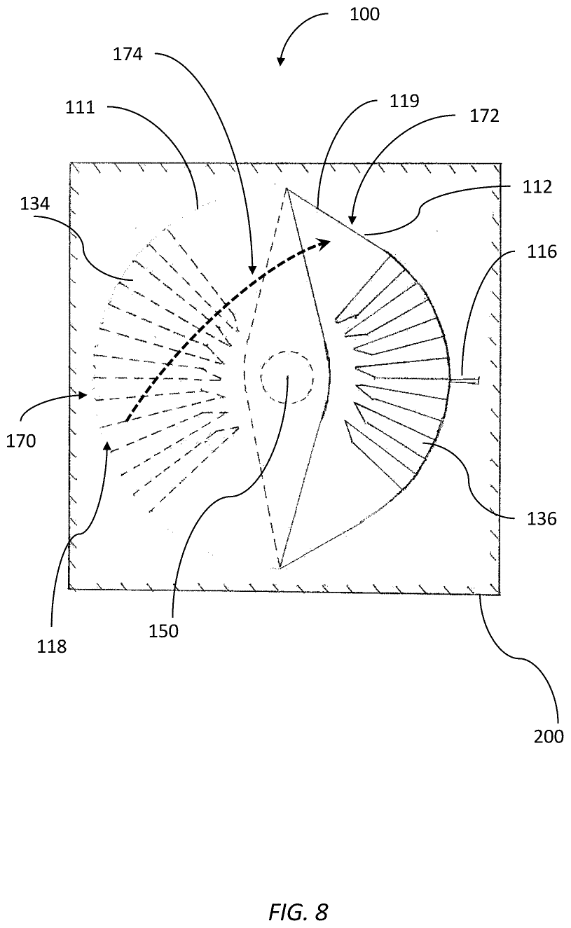

With reference to FIG. 2, FIG. 3, FIG. 4, FIG. 6, FIG. 7, and FIG. 8, the apparatus 100 further comprises a shallow-profile wind turbine 180. The shell structure 110 encloses the shallow-profile wind turbine 180. The shallow-profile wind turbine 180 comprises a turbine hub 181 and a plurality of turbine blades 185. The lower part of the shallow-profile wind turbine 180 may be covered with the bypass prevention shell 114. The turbine hub 181 also houses an electrical generator 140. The shallow-profile wind turbine 180 captures a portion of the energy in the wind flow 174 passing through the shell structure 110, converting the movement of the wind flow 174 pushing on the plurality of turbine blades 185 into rotational energy, spinning the shallow-profile wind turbine 180. In some aspects of the present invention, the upper shell 111 may further comprise a plurality of upper-shell-fixed-blades 134. In some aspects of the present invention, the lower nosing shell 112 may further comprise a plurality of lower-shell-fixed-blades 136. Where either the plurality of upper-shell-fixed-blades 134 and/or the plurality of lower-shell-fixed-blades 136 are present in an embodiment of the present invention, the plurality of upper-shell-fixed-blades 134 and/or the plurality of lower-shell-fixed-blades 136 contribute to directing wind towards the plurality of turbine blades 185. The plurality of upper-shell-fixed-blades 134 and/or the plurality of lower-shell-fixed-blades direct the wind flow 174 towards the plurality of turbine blades 185, improving the efficiency of the shallow-profile wind turbine 180. Within the turbine hub 181, an electrical generator 140 is mounted, to generate electricity as the shallow-profile wind turbine 180 rotates. The shallow-profile wind turbine 180 rotates on a turbine axis 186. The turbine axis 186 may be tilted from the vertical, that is, be inclined relative to a vertical reference, by an amount of a tilt angle 190. The tilt angle 190 may be up to approximately 45°, and advantageously may be up to approximately 30°, or up to approximately 15°, or up to approximately 10°, or up to approximately 5°, or another amount.

The turbine axis 186 may also be positioned with a setback 155 from the axis 151 of the central columnar support mount 150. This enables the shell structure 110 to align with the prevailing wind direction. Alternatively, it may be mounted neutral (setting the setback 155 to be null) or set forward with respect to the axis 151 of the central columnar support mount 150 in which case additional means such as wind vanes or electro-mechanical or mechanical articulation control apparatus will be provided to align the shell structure 110 with the prevailing wind direction.

In some aspects of the present disclosure, the dimensions and geometric layout of the apparatus 100 and associated parameters including but not limited to height 152 of the central columnar support mount 150, the setback 155 or the set forward dimension, the tilt angle 190, a size and a shape of an additional cladding 210. and other factors, may be determined by analysis and simulations incorporating a plurality of information about an existing structure 200 to optimize power production considering specific features of the existing structure 200 and a location of the existing structure 200.

In some aspects of the present disclosure situations the plurality of wind intake zones 118 and the plurality of wind egress zones 119 of the shell structure 110 may be reversed with regard to the arrangement shown.

In some aspects of the present disclosure, the apparatus 100 may comprise a plurality of upper shells 111, enclosing a plurality of spaces. Each of the plurality of spaces may contain a plurality of the shallow-profile wind turbines 180, specifically a single shallow-profile wind turbine 180 or multiple shallow-profile wind turbines 180.

In some aspect of the present disclosure, a plurality of outer surfaces of the shell structure 110 may further comprise photovoltaic cells or other devices to convert sunlight to electricity.

Certain aspects of the present disclosure were described above. From the foregoing it will be seen that this disclosure is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present disclosure is not limited to those aspects described above, but rather the intention is that additions and modifications to what was expressly described herein are also included within the scope of the disclosure. Moreover, it is to be understood that the features of the various aspects described herein are not mutually exclusive and can exist in various combinations and permutations, even if such combinations or permutations were not made express herein, without departing from the spirit and scope of the disclosure. In fact, variations, modifications, and other implementations of what was described herein will occur to those of ordinary skill in the art without departing from the spirit and the scope of the disclosure. As such, the disclosure is not to be defined only by the preceding illustrative description.

Accordingly, what is claimed is:

1. An apparatus for wind-energy electrical generation, the apparatus comprising a shell structure and a central columnar support mount and a shell structure articulation base, and wherein the shell structure is mounted on the central columnar support mount; and wherein the central columnar support mount comprises an axis, and wherein the apparatus may rotate about the axis using the shell structure articulation base; and wherein the central columnar support mount comprises a height, and wherein the central columnar support mount is attached to an existing structure; and wherein the apparatus further comprises a shallow-profile wind turbine, enclosed within the shell structure, and wherein the shallow-profile wind turbine comprises a turbine hub and a plurality of turbine blades, and the shallow-profile wind turbine rotates on a turbine axis.

2. The apparatus of claim 1, wherein the axis is vertical.

3. The apparatus of claim 1, wherein the axis is approximately vertical.

4. The apparatus of claim 1, wherein the shell structure comprises an upper shell, a lower nosing shell, and a bypass prevention shell, and wherein the upper shell, lower nosing shell, and the bypass prevention shell are securely affixed to each other.

5. The apparatus of claim 1, wherein the shell structure comprises a plurality of directional vanes.

6. The apparatus of claim 1, wherein the shell structure comprises a plurality of wind intake zones and a plurality of wind egress zones.

7. The apparatus of claim 6, wherein the plurality of wind intake zones are provided with wind-porous screens, and the plurality of wind egress zones are provided with wind-porous screens.

8. The apparatus of claim 1, wherein the shell structure articulation base is pivoted with a setback from the axis.

9. The apparatus of claim 4, wherein the shell structure and the existing structure generate a region of relatively increased air pressure on a windward side of the shell structure and a region of relatively reduced air pressure on a leeward side of the shell structure, and wherein a difference in air pressure and air velocity drives a wind flow through the shell structure and through the shallow-profile wind turbine.

10. The apparatus of claim 1, wherein the turbine hub houses an electrical generator.

11. The apparatus of claim 1, wherein the turbine axis is tilted from a vertical reference by an amount of a tilt angle.

12. The apparatus of claim 1, wherein the turbine axis is positioned with a setback from the axis of the central columnar support mount.

13. The apparatus of claim 1, wherein the apparatus comprises a plurality of upper shells, enclosing a plurality of spaces, and wherein each of the plurality of spaces contains a plurality of shallow-profile wind turbines.

14. The apparatus of claim 1, wherein a plurality of outer surfaces of the shell structure further comprise photovoltaic cells.

15. An apparatus for wind-energy electrical generation, the apparatus comprising a shell structure and a central columnar support mount and a shell structure articulation base, and wherein the shell structure is mounted on the central columnar support mount, and wherein the shell structure comprises an upper shell, a lower nosing shell, and a bypass prevention shell, and wherein the upper shell, lower nosing shell, and the bypass prevention shell are securely affixed to each other, and wherein the shell structure comprises a plurality of wind intake zones and a plurality of wind egress zones; and wherein the central columnar support mount comprises an axis, and wherein the apparatus may rotate about the axis using the shell structure articulation base; and wherein the central columnar support mount comprises a height, and wherein the central columnar support mount is attached to an existing structure; and wherein the apparatus further comprises a shallow-profile wind turbine, enclosed within the shell structure, and wherein the shallow-profile wind turbine comprises a turbine hub and a plurality of turbine blades, and the shallow-profile wind turbine rotates on a turbine axis.

16. The apparatus of claim 15, wherein the shell structure articulation base is pivoted with a setback from the axis.

17. The apparatus of claim 15, wherein the turbine axis is tilted from a vertical reference by an amount of a tilt angle, the tilt angle being up to approximately 45°; and wherein the turbine axis is positioned with a setback from the axis of the central columnar support mount.

18. The apparatus of claim 15, wherein the apparatus comprises a plurality of upper shells, enclosing a plurality of spaces, and wherein each of the plurality of spaces contains a plurality of shallow-profile wind turbines.

19. The apparatus of claim 15, wherein the upper shell further comprises a plurality of upper-shell-fixed-blades, and the lower nosing shell further comprises a plurality of lower-shell-fixed-blades, wherein the plurality of upper-shell-fixed-blades and the plurality of lower-shell-fixed-blades direct a wind flow towards the plurality of turbine blades.

20. An apparatus for wind-energy electrical generation, the apparatus comprising a shell structure and a central columnar support mount and a shell structure articulation base, and wherein the shell structure is mounted on the central columnar support mount, and wherein the shell structure comprises a plurality of wind intake zones and a plurality of wind egress zones; and wherein the central columnar support mount comprises an axis, and wherein the apparatus may rotate about the axis using the shell structure articulation base; and wherein the central columnar support mount comprises a height, and wherein the central columnar support mount is attached to an existing structure; and wherein the apparatus further comprises a shallow-profile wind turbine, enclosed within the shell structure, and wherein the shallow-profile wind turbine comprises a turbine hub and a plurality of turbine blades, and the shallow-profile wind turbine rotates on a turbine axis; and wherein a plurality of dimensions and geometric layout of the apparatus and associated parameters including but not limited to the height of the central columnar support mount, a setback dimension, a tilt angle, and a size and a shape of an additional cladding, may be determined by analysis and simulations incorporating a plurality of information about an existing structure to optimize power production.
